(19) United States
(12) Patent Application Publication
(10) Pub. No.: US 2025/0292591 A1
(43) Pub. Date: Sep. 18, 2025

(54) TRAFFIC OBJECT RECOGNITION SYSTEMS AND METHODS

(71) Applicant: QUALCOMM Incorporated, San Diego, CA (US)

(72) Inventors: Sourab Bapu Sridhar, Jarna (SE); Venkatraman Narayanan, Farmington Hills, MI (US); Varun Ravi Kumar, San Diego, CA (US); Senthil Kumar Yogamani, Headford (IE); Kiran Bangalore Ravi, Paris (FR)

(21) Appl. No.: 18/605,264

(22) Filed: Mar. 14, 2024

(51) Int. Cl. G06V 20/58; G06T 7/50; G06V 10/44; G06V 10/56; G06V 30/10

(52) U.S. Cl. CPC G06V 20/582; G06T 7/50; G06V 10/44; G06V 10/56; G06V 20/584; G06V 30/10

(57) ABSTRACT

This disclosure provides systems, methods, and devices for vehicle driving assistance systems that support image processing. In a first aspect, the methods addresses traffic sign recognition as a language model-based image reasoning task by utilizing a multi-modal transformer architecture that combines the strength of vision and language machine learning (ML) models. The transformer architecture recognizes traffic signs based on visual features and associated taxonomy of the traffic signs. In a second aspect, the methods leverage context surrounding an autonomous vehicle through a graph-based modeling framework that fuses outputs from multiple perception modules to construct a semantic scene graph representation of an intersection, which consolidates processing diverse data types for traffic light relevancy detection. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection. Various driving, or movement, assistance systems have also been produced in machine automation generally, such as in robotics.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road. Aspects of this disclosure also provide improved systems for assisting users of non-vehicle systems such as robotics.

Example embodiments may improve autonomous driving systems through improved object recognition and relevancy detection, although aspects of the object recognition and relevancy detection processing described herein may also be applied to other applications, such as object recognition on camera systems, including camera systems on mobile phones, or such as other machine control-assistance systems or automation systems generally. Object recognition and relevancy detection techniques may be used to identify a purpose and relevancy of one or more objects detected in a scene. Examples of fields where a device may determine the purpose and/or relevancy of detected objects include autonomous driving by autonomous driving systems (e.g., of autonomous vehicles), autonomous navigation by a robotic system, among others. For example, a three-dimensional (3D) environment may include traffic objects to facilitate navigation through the environment, such as traffic signs and traffic lights. It can be important for the autonomous driving system to process and determine the relevancy of the text information included on the traffic signs in order to accurately navigate the space relative to such information. It can also be important for the autonomous driving system to determine which traffic light(s) of a plurality of traffic lights is relevant to the autonomous driving system in order to accurately and safely navigate a complex intersection.

Traffic object recognition is a component of a perception system of an autonomous vehicle. Recognizing traffic objects enables the vehicle to understand and interpret the road environment accurately, make informed decisions, comply with traffic regulations, and ensure the safety of passengers, pedestrians, and other road users. Traffic object recognition in autonomous vehicles improves safety. For instance, errors in traffic object recognition can lead to traffic violations, unsafe maneuvers, disruption of traffic flow, unnecessary stops, loss of user trust, and safety hazards. Errors can also result in inefficient route planning, unexpected vehicle behavior, legal and liability issues, and near miss incidents.

When the traffic object is a traffic sign, traffic sign recognition has conventionally been approached as a deep learning problem, where machine learning models are trained to classify and detect traffic signs based on pixel-level image features. Relying only on pixel-level image features, however, presents significant technical challenges for accurately recognizing and adapting to different traffic signs around the world, which vary by country.

Aspects of this disclosure address traffic sign recognition as a language model-based image reasoning task that combines the strengths of language models and computer vision, which results in contextually-informed reasoning, ambiguity resolution, and multimodal understanding for the recognition system. As such, the present techniques exhibit improved accuracy, adaptability, and interpretability of traffic signs compared to conventional approaches relying only upon pixel-level image features. For instance, the techniques enable capturing diverse traffic sign designs, determining precise localization, handling variations in lighting and environmental conditions, and understanding contextual information, which improves the accuracy and adaptability of a recognition system relying on the techniques described herein.

Example embodiments provide methods for traffic sign recognition that include employing a multi-modal transformer architecture that combines the strengths of vision and language models. The transformer architecture can be enhanced by using contrastive learning, image-grounded text generation, and image-text matching techniques. In this way, a trained machine learning model can effectively recognize traffic signs based on both visual features and associated taxonomy of a traffic sign.

As used herein, traffic signs are visual cues placed along roads and streets to convey important information, regulate traffic, and ensure road safety. Traffic signs use symbols, colors, and shapes to communicate messages quickly and universally. There are several types of traffic signs, including regulatory signs that indicate laws and rules, warning signs that alert drivers to potential hazards, and informational signs that provide guidance or directions. Additionally, there are road work signs, guide signs, and emergency management signs. In general, a traffic sign is any signage that assists drivers, pedestrians, cyclists, autonomous vehicle systems, or driver-assistance systems in navigating roads safely and efficiently.

Aspects of this disclosure also improve real-time traffic light relevancy detection for autonomous driving systems navigating complex intersections. The provided techniques leverage context surrounding an autonomous vehicle through an innovative graph-based modeling framework that enhances robustness and adaptability of traffic light relevancy detection, which allows the autonomous vehicle to safely handle complex intersection scenarios. For example, the techniques fuse outputs from multiple perception modules such as vehicle tracking, lane detection etc. to construct a semantic scene graph representation of an intersection. Graph neural networks encode the contextual information from these perception modules into embeddings to jointly infer static lane-light associations and dynamic vehicle-light assignments over time. By integrating multi-modal data, the algorithm achieves a more accurate and adaptive understanding of an intersection state for reliable maneuvering and decision making.

In one aspect of the disclosure, a method for determining at least one natural language descriptor of a traffic sign includes receiving a plurality of image frames. A traffic sign is depicted in the plurality of image frames. The method further includes extracting image features corresponding to the traffic sign based on the at least one image frame; determining, using at least one machine learning model, an embedding based on the image features and text included on the traffic sign; and determining, using the at least one machine learning model, at least one natural language descriptor of the traffic sign based on the embedding.

In an additional aspect of the disclosure, an apparatus includes at least one processor and a memory coupled to the at least one processor. The at least one processor is configured to perform operations including receiving a plurality of image frames. A traffic sign is depicted in the plurality of image frames. The operations further include extracting image features corresponding to the traffic sign based on the at least one image frame; determining, using at least one machine learning model, an embedding based on the image features and text included on the traffic sign; and determining, using the at least one machine learning model, at least one natural language descriptor of the traffic sign based on the embedding.

In an additional aspect of the disclosure, a method of training a machine learning model includes providing first image features to an image transformer of a transformer of the machine learning model. The first image features correspond to a plurality of image frames depicting a plurality of traffic signs. The method further includes providing encoded natural language descriptors to a text transformer of the transformer. The natural language descriptors correspond to the plurality of traffic signs. The transformer is trained to output embeddings that each combine second image features output by the image transformer and text features output by the text transformer. The second image features correspond to a traffic sign of the plurality of traffic signs and the text features correspond to the traffic sign. The method also includes training a decoder large language machine learning model of the machine learning model based on the embeddings to output at least one natural language descriptor corresponding to the traffic sign.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mm Wave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating a system for determining at least one natural language descriptor of a traffic sign according to one or more aspects of the disclosure.

FIG. 5 is a block diagram of an example machine learning (ML) model represented by an artificial neural network (ANN) according to one or more aspects of the disclosure.

FIG. 6 is a flow diagram illustrating an example pipeline for training a machine learning model for traffic sign recognition according to one or more aspects of the disclosure.

FIG. 7 is a flow diagram illustrating an example pipeline for determining at least one natural language descriptor of a traffic sign according to one or more aspects of the disclosure.

FIG. 8 is a flow chart illustrating an example method for training a machine learning model for traffic sign recognition according to one or more aspects of the disclosure.

FIG. 9 is a flow chart illustrating an example method for determining at least one natural language descriptor of a traffic sign according to one or more aspects of the disclosure.

FIG. 10 is a flow diagram illustrating an example pipeline for determining traffic light relevancy according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support traffic object recognition using a ML model. Traffic objects may be, for example, traffic signs or traffic lights. With respect to traffic signs, the methods address traffic sign recognition as a language model-based image reasoning task. For instance, the methods utilize a multi-modal transformer architecture that combines the strength of vision and language ML models. The transformer architecture can be used to learn the relationship between images and text, enabling the ML model to recognize traffic signs based on visual features and associated taxonomy of the traffic signs. Learning the relationship between image embeddings and text embeddings is in part based on contrastive learning, which encourages positive pairs (e.g., image to text pairs) to be close and negative pairs (e.g., image text pairs from different classes) to be distant in a shared embedding space. Image-grounded text generation is used to generate detailed textual descriptions based on the input images, which enables the ML model to recognize the traffic signs by understanding the importance of different regions of the image and the corresponding words in the text. Image-text matching techniques is used to perform fine grained alignment between image and text embeddings.

In this way, the multi-modal attention mechanism of the transformer architecture in the present techniques forces the ML model to understand the importance of different regions of the image and the corresponding words in the text, which contributes to generating coherent and contextually relevant textual descriptions. By employing the multi-modal transformer architecture, contrastive learning, image-grounded text generation, and image-text matching techniques, the ML model can effectively recognize traffic signs based on the visual features and associated taxonomy of the traffic signs. In various embodiments, the ML model may be fine-tuned on a traffic sign recognition dataset to lean the specific patterns and relationships associated with different traffic signs.

With respect to traffic lights, the methods leverage context surrounding an autonomous vehicle through an innovative graph-based modeling framework that enhances robustness and adaptability of traffic light relevancy detection. For example, the techniques fuse outputs from multiple perception modules such as vehicle tracking, lane detection, etc. to construct a semantic scene graph representation of an intersection, which consolidates processing diverse data types for traffic light relevancy detection. A semantic scene graph is constructed to capture relationships between traffic lights, lanes and vehicles to model the intersection, which enables structured data fusion. Additionally, separate bipartite graphs are generated to represent lane-traffic light and vehicle-traffic light relationships to capture relevancy in relation to both static and dynamic objects. In this way, graph neural networks encode the contextual information from the perception modules into embeddings to jointly infer static lane-light associations and dynamic vehicle-light assignments over time. By integrating multi-modal data, the algorithm achieves more accurate and adaptive understanding of state of an intersection for reliable maneuvering and decision making.

Particular implementations of the subject matter described in this disclosure may be implemented to realize one or more of the following potential advantages or benefits. In some aspects, the present disclosure provides techniques for image processing that may be particularly beneficial in smart vehicle applications. In particular, these techniques may enable more accurate tracking of traffic objects, such as traffic signs or traffic lights. One benefit of improved tracking of traffic objects is that it allows vehicle control systems to more accurately understand and interpret the road environment, make informed decisions, and comply with traffic regulations, and navigate a vehicle more safely with respect to passengers, pedestrians, and other road users. These improvements can also extend to driver assistance systems, which can benefit from increased monitoring capabilities. By expanding the range of traffic objects that can be recognized, these systems can offer more accurate alerts and assistance to drivers when necessary, without generating unnecessary notifications or distractions.

With respect to traffic signs, better tracking capabilities enables vehicles to recognize traffic signs more accurately despite two traffic signs with the same intention having different visual appearances (e.g., a new stop sign versus a faded stop sign) or with similar visual appearances but different intentions (e.g., two yellow, diamond-shaped signs with different words). For example, traffic signs are highly local in nature. Every country and every state in the United States has its own sets of traffic signs. An advantage of the present techniques is the generalized capability of the ML model that makes the ML model highly adaptable. Using a multi-modal transformer architecture allows the ML model to capture the holistic semantic context of the scene, which significantly reduces the need for a large amount of annotated data for newer traffic signs with minor differences as compared to conventional pixel-level feature based approaches. Additionally, ambiguities often arise in traffic sign recognition due to traffic signs having similar visual appearances. The present technique benefits from recognizing the textual features to disambiguate such cases. By considering the context and textual cues, the ML model can make more informed decisions about the intended meaning of a traffic sign with similar visual features to another.

Another advantage of the present techniques with respect to traffic signs is that leveraging large language models for image summarization introduces a sophisticated reasoning mechanism. The large language model is capable of interpreting and generating natural language text, which, can help the ML model reason about the visual content of traffic signs based on both the visual appearance of the traffic sign and the textual information the traffic sign conveys (e.g., speed limits, warnings, etc.) This language-based reasoning enhances recognition accuracy and fosters a more comprehensive understanding of the intended meaning of traffic signs.

An additional advantage of the present techniques with respect to traffic sign recognition is the enhanced understanding of the decision making process of the ML model. For instance, since the techniques are grounded in a language model, the ML model can generate human-readable, natural language explanations for the recognition decisions that the ML model makes. Understanding the reasoning process of the ML model enhances trust and facilitates identification of potential failures, which is particularly beneficial in safety critical applications like autonomous driving.

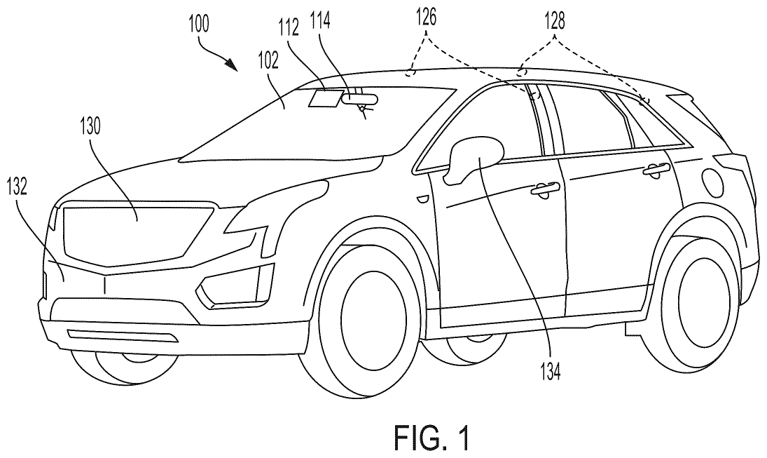

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

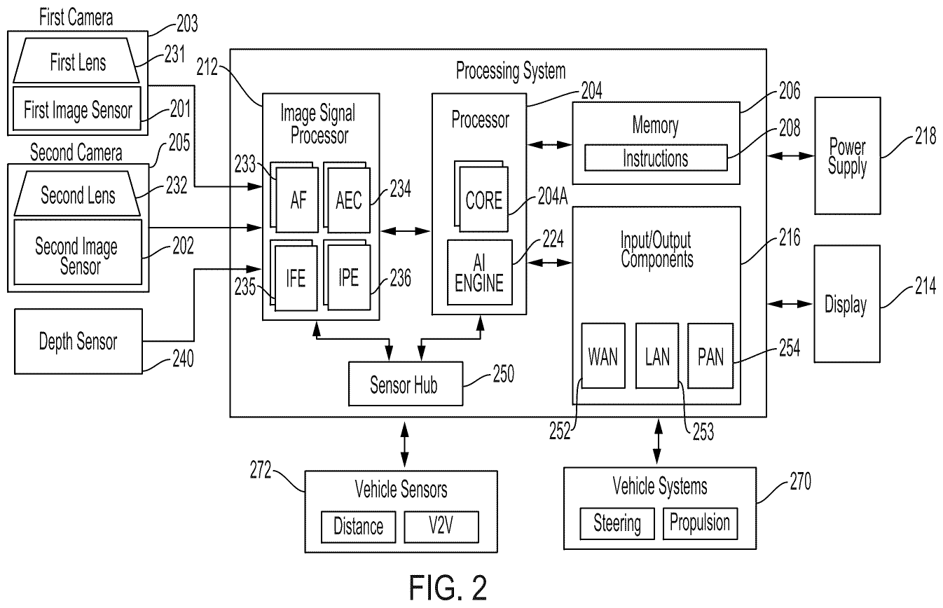

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The device 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 114 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

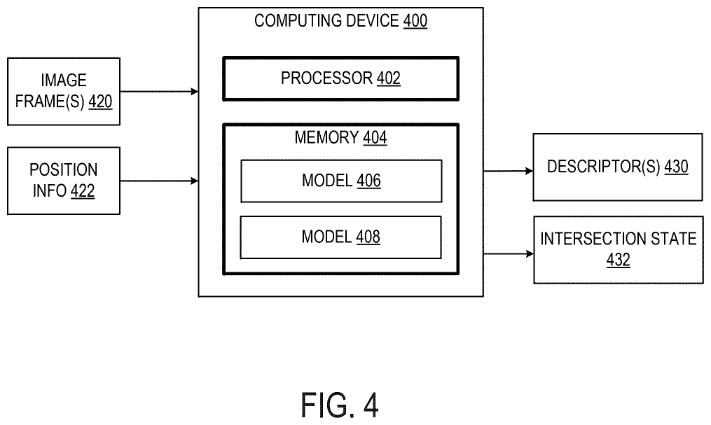

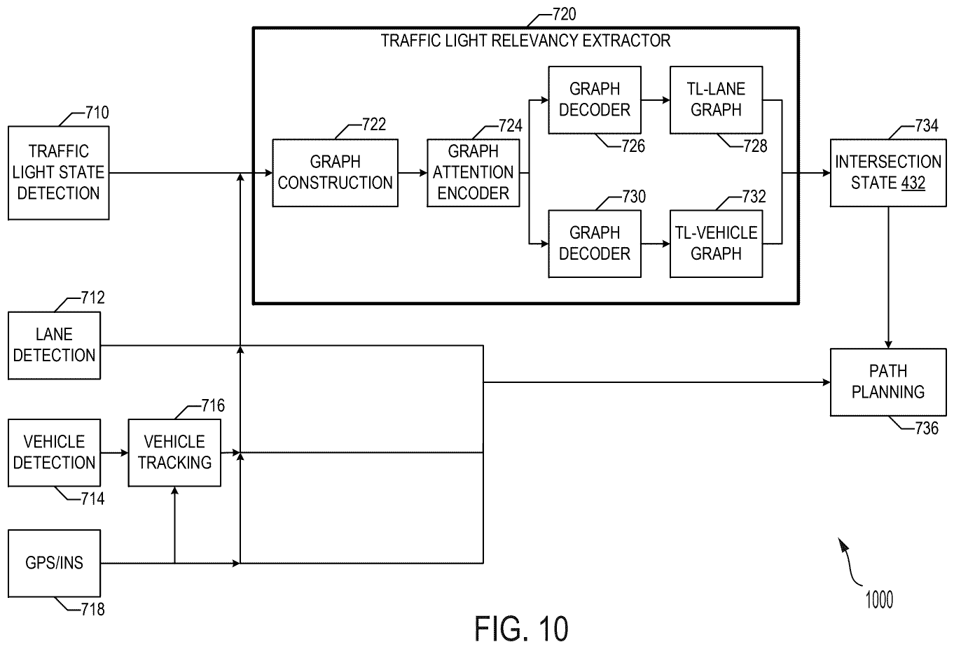

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination). The accuracy of the output of commands to the vehicle systems 270 may be improved according to embodiments of this disclosure by using one or more machine learning models, such as that described in connection with FIGS. 4-7, to determine the meaning of traffic signs that can affect the commands sent to the vehicle systems 270. The accuracy of the output of commands to the vehicle systems 270 may also be improved according to embodiments of this disclosure by using one or more machine learning models, such as that described in connection with FIGS. 4 and 10, to output more accurate traffic light relevancy determinations that can affect the commands sent to the vehicle systems 270.

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

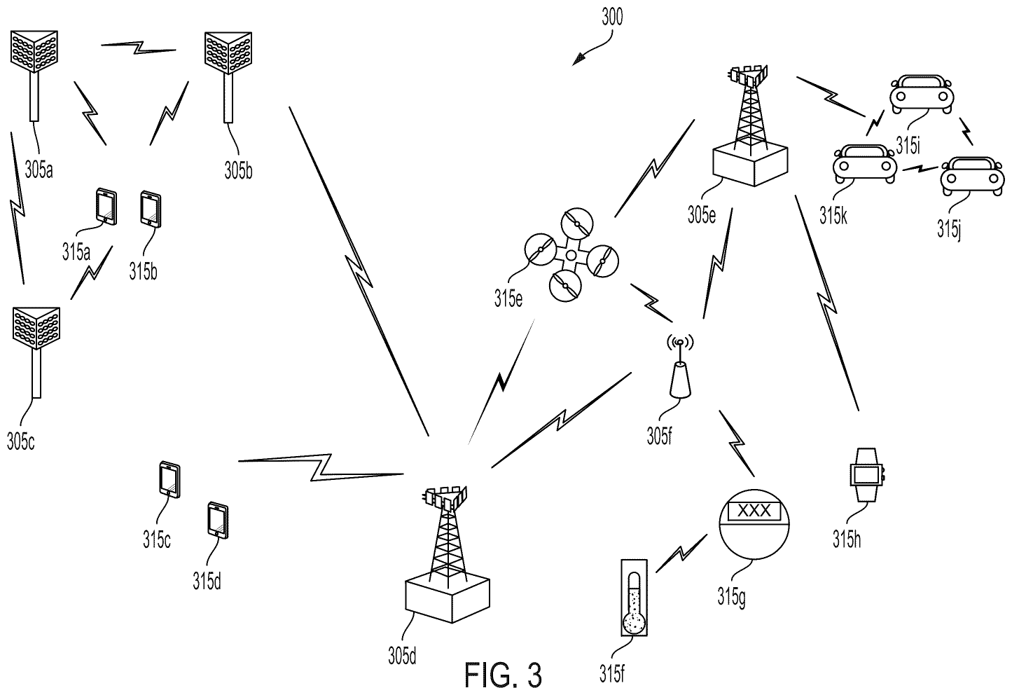

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (COMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports communications with ultra-reliable and redundant links for certain devices. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

Aspects of the vehicular systems described with reference to, and shown in, FIG. 1, FIG. 2, and FIG. 3 may include systems and methods for traffic object recognition. FIG. 4 is a block diagram illustrating an example computing device 400. Computing device 400 receives as input at least one image frame 420 that includes a traffic object, and in some embodiments, position information 422. The position information 422 may be received from a system including a global positioning system and an inertial navigation system (e.g., a GPS/INS system). In some embodiments, the computing device 400 outputs at least one descriptor 430 of a traffic sign. The descriptor 430 is represented as natural language, human-readable text. In some embodiments, computing device 400 outputs an intersection state 432 based on the at least one image frame 420 and the position information 422. The at least one image frame 420 may be captured by one or more cameras on a vehicle as the vehicle drives through an environment. For example, different cameras on the vehicle may capture different portions or angles of a traffic sign or traffic light in a set of image frames 420. Computing device 400 may be implemented by the image processing configuration of FIG. 2 or by one or more of the components illustrated in FIG. 3.

Computing device 400 includes a processor 402 (e.g., processor 204) coupled to a memory 404 (e.g., memory 206). In various aspects, processor 402 may include more than one processor. For example, processor 402 may include a first processor 402A (not shown) and a second processor 402B (not shown) that are each coupled to the memory 404. The first processor 402A may be in communication with the second processor 402B. The first processor 402A and the second processor 402B may each perform all of the operations performed by processor 402, or alternatively, the first processor 402A may only perform a first portion of the operations and the second processor 402B may only perform a second portion of the operations.

In various embodiments, memory 404 may include more than one memory. For example, memory 404 may include a first memory 404A (not shown) and a second memory 404B (not shown) that are each coupled to processor 402. The first memory 404A and the second memory 404B may each store all of the processor-executable code for all of the operations of processor 402, or alternatively, the first memory 404A may only store a first portion of the processor-executable code and the second memory 404B may only store a second portion of the processor-executable code. In another example, processor 402 may include the first processor 402A and the second processor 402B that are each coupled to a first memory 404A (not shown) and a second memory 404B (not shown) of memory 404. In another example, processor 402 may include the first processor 402A coupled to the first memory 404A of memory 404, but not to the second memory 404B of memory 404, and the second processor 402B coupled to the second memory 404B, but not to the first memory 404B.

In embodiments in which processor 402 includes two or more processors, the two or more processors may be included with the same computing device 400, or may be suitably separated among two or more computing devices 400. In embodiments in which memory 404 includes two or more memories, the two or more memories may be included with the same computing device 400, or may be suitably separated among two or more computing devices 400. The computing device(s) 400 with which the two or more memories of memory 404 are included may be the same computing device(s) 400 with which the at least one processor of processor 402 is included or may be different. For example, a processor 402 may be included with a first computing device 400A (not shown) and a memory 404 may be included with a second computing device 400B (not shown), e.g., a server, in communication with the first computing device 400A over a network.

The at least one memory 404 stores a model 406 for traffic sign recognition and a model 408 for traffic sign relevancy detection. Model 406 is trained to output one or more descriptors of a traffic sign based on the traffic sign's visual appearance and textual information that together provide a semantic understanding of the traffic sign. In this way, model 406 predicts the at least one descriptor 430 based on the at least one image frame 420. For example, model 406 may be implemented as one or more machine learning models, including supervised learning models, unsupervised learning models, other types of machine learning models, and/or other types of predictive models. For example, model 406 may be implemented as one or more of a neural network, a transformer model, a decision tree model, a support vector machine, a Bayesian network, a classifier model, a regression model, and the like.

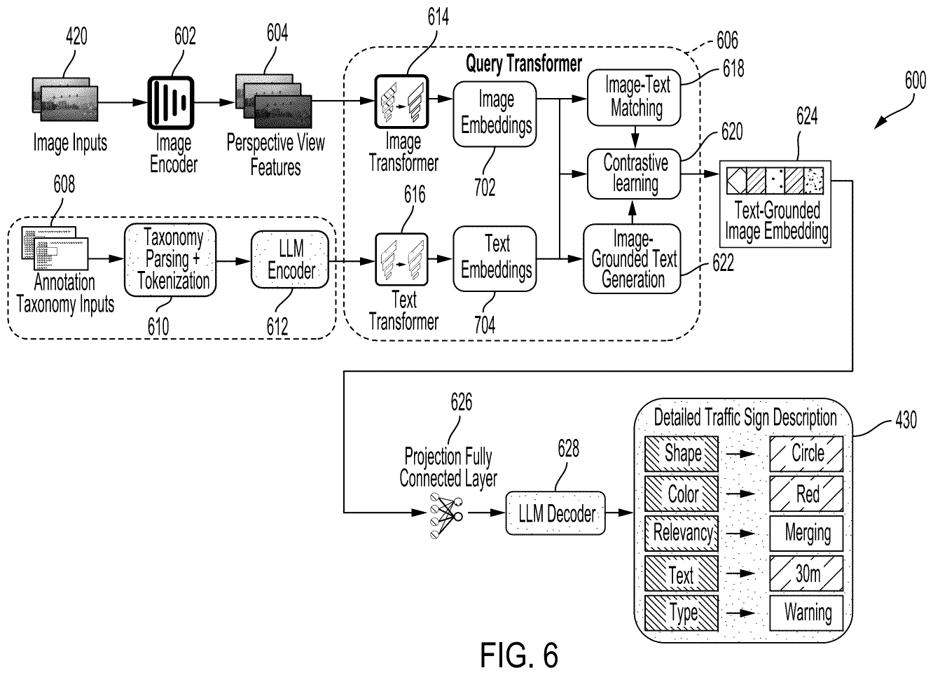

Model 406 may be trained based on training data to determine one or more natural language descriptors of a traffic sign. For example, one or more training datasets may be used that contain image frames depicting traffic signs and text annotations associated with the traffic signs. The training data sets may specify one or more expected outputs. For example, natural language text that is included on a traffic sign. Parameters of model 406 may be updated based on whether model 406 generates correct outputs when compared to the expected outputs. In particular, model 406 may receive one or more pieces of input data from the training data sets that are associated with a plurality of expected outputs. Model 406 may generate predicted outputs based on a current configuration of model 406. The predicted outputs may be compared to the expected outputs and one or more parameter updates may be computed based on differences between the predicted outputs and the expected outputs. In particular, the parameters may include weights (e.g., priorities) for different features and combinations of features (e.g., image features and text features). The parameter updates to model 406 may include updating one or more of the features analyzed and/or the weights assigned to different features or combinations of features (e.g., relative to the current configuration of model 406). Additional description of training model 406 is provided in connection with FIG. 6 below.

Model 408 is trained to output a state of an intersection that includes a plurality of traffic lights based on contextual outputs from multiple perception modules that process image data. The state of the intersection includes associations between traffic lanes and traffic lights and between vehicles and traffic lights. In this way, model 408 predicts the state of the intersection based on the at least one image frame 420. For example, model 408 may be implemented as one or more machine learning models, including supervised learning models, other types of machine learning models, and/or other types of predictive models. For example, model 408 may be implemented as one or more of a neural network, a transformer model, a decision tree model, a support vector machine, a Bayesian network, a classifier model, a regression model, and the like.

Model 408 may be trained based on training data to determine intersection state. For example, one or more training datasets may be used that contain perception module outputs and position information. The training data sets may specify one or more expected outputs. For example, correct associations between traffic lanes and traffic lights and between vehicles and traffic lights. Parameters of model 408 may be updated based on whether model 408 generates correct outputs when compared to the expected outputs. In particular, model 408 may receive one or more pieces of input data from the training data sets that are associated with a plurality of expected outputs. Model 408 may generate predicted outputs based on a current configuration of model 408. The predicted outputs may be compared to the expected outputs and one or more parameter updates may be computed based on differences between the predicted outputs and the expected outputs. In particular, the parameters may include weights (e.g., priorities) for different features and combinations of features (e.g., traffic lanes, vehicle trajectory, position information). The parameter updates to model 408 may include updating one or more of the features analyzed and/or the weights assigned to different features or combinations of features (e.g., relative to the current configuration of model 408).

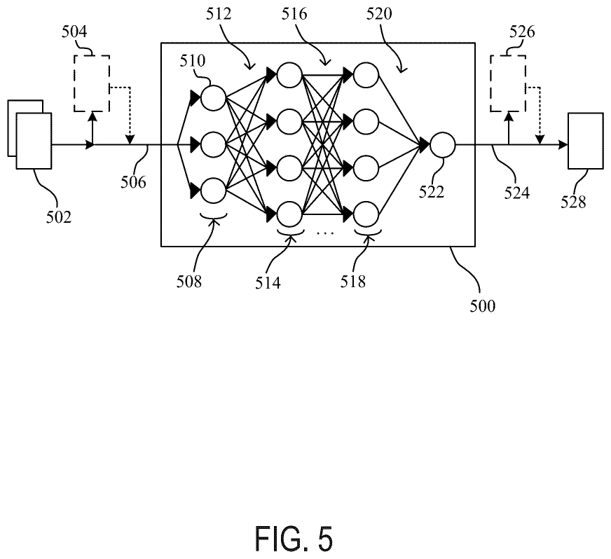

FIG. 5 is an illustrative block diagram of an example machine learning (ML) model, that may be implemented as model 406 or model 408, represented by an artificial neural network (ANN) 500. ANN 500 may receive input data 506 which may include one or more bits of data 502, pre-processed data output from pre-processor 504 (optional), or some combination thereof. Here, data 502 may include training data, verification data, application-related data, or the like, e.g., depending on the stage of deployment of ANN 500. Pre-processor 504 may be included within ANN 500 in some other implementations. Pre-processor 504 may, for example, process all or a portion of data 502 which may result in some of data 502 being changed, replaced, deleted, etc. In some implementations, pre-processor 504 may add additional data to data 502. In some implementations, the pre-processor 504 may be a ML model, such as an ANN.

ANN 500 includes at least one first layer 508 of artificial neurons 510 to process input data 506 and provide resulting first layer data via edges 512 to at least a portion of at least one second layer 514. Second layer 514 processes data received via edges 512 and provides second layer output data via edges 516 to at least a portion of at least one third layer 518. Third layer 518 processes data received via edges 516 and provides third layer output data via edges 520 to at least a portion of a final layer 522 including one or more neurons to provide output data 524. All or part of output data 524 may be further processed in some manner by (optional) post-processor 526. Thus, in certain examples, ANN 500 may provide output data 528 that is based on output data 524, post-processed data output from post-processor 526, or some combination thereof. Post-processor 526 may be included within ANN 500 in some other implementations. Post-processor 526 may, for example, process all or a portion of output data 524 which may result in output data 528 being different, at least in part, to output data 524, e.g., as result of data being changed, replaced, deleted, etc. In some implementations, post-processor 526 may be configured to add additional data to output data 524. In this example, second layer 514 and third layer 518 represent intermediate or hidden layers that may be arranged in a hierarchical or other like structure. Although not explicitly shown, there may be one or more further intermediate layers between the second layer 514 and the third layer 518. In some implementations, the post-processor 526 may be a ML model, such as an ANN.

The structure and training of artificial neurons 510 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process or during operation of the ML model. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the configuration for the ML model to change in response to identifying complex patterns and relationships in the input data 506 and determinations that should be made when those complex patterns and relationships are identified in the input data. Some non-exhaustive example activation functions include a sigmoid based activation function, a hyperbolic tangent (tanh) based activation function, a convolutional activation function, up-sampling, pooling, and a rectified linear unit (ReLU) based activation function.

FIG. 6 is a flow diagram of an example pipeline 600 for training the model 406. The model 406 includes an image encoder 602, a query transformer 606 including an image transformer 614 and a text transformer 616, an adaptation ML model 626, and a large language model decoder 628 (e.g., a neural network). Each of the encoders, decoders, and transformers is a ML model. During the training phase, the model 406 accepts two types of inputs, one based on image data including the at least one image frame 420 and the other based on annotation taxonomy data 608. The at least one image frame 420 includes visual input where a traffic sign need to be recognized. In an example, the at least one image frame 420 is represented by an image tensor S with dimensions [H, W, C], wherein H is the height of the image frame 420, W is the width of the image frame 420, and C is the number of color channels (e.g., 3 for red-green-blue (RGB)) of the image frame 420. The at least one image frame 420 is provided to an image encoder 602, which outputs features of the at least one image frame 420, such as perspective view features 604. The perspective view features 604 are provided to the image transformer 614 of the query transformer 606.

The annotation taxonomy data 608 provides structured text information about different traffic sign categories, labels, and attributes, which assists the model 406 in understanding and recognizing the context and meaning of traffic signs. In an example, the annotation taxonomy data 608 is organized in a hierarchical manner and contains several attributes and metadata about a plurality of traffic signs from manual human annotations. Example attributes and metadata include a unique identifier or label for a category of traffic signs (e.g., regulatory signs, informational signs, etc.), a textual description or definition of the meaning and purpose of the category (e.g., children), and attributes or properties that characterize the category such as traffic sign shape, color, type (e.g., speed limit), or relevancy (e.g., only for vehicles turning right on red).

The annotation taxonomy data 608 is processed to be used as input for the text transformer 616, which involves tokenization, positional encodings, and transformation into embedding vectors. At block 610 of pipeline 600, the hierarchical labels and elements of the annotation taxonomy data 608 are converted to tokens, such as by using a tokenizer function that splits the input text into individual tokens. To retain the hierarchy and relationships among the tokens, positional encodings are introduced, such as by using a position encoding function that assigns a unique value to each token based on a position of the token in the sequence. A large language model encoder 612 (e.g., a neural network) then encodes the tokenized and positionally encoded annotation taxonomy data 608 into embedding vectors by converting the input tokens into continuous vector representations. The embedding vectors (e.g., text embeddings) represent the semantic context of traffic signs and are provided to the text transformer 616 of the query transformer 606.

The query transformer 606 is trained based on the perspective view features 604 provided to the image transformer 614 and the text embeddings provided to the text transformer 616 to output joint embeddings (e.g., text-grounded image embedding 624) that link the visual inputs and textual descriptions, which allows the model 406 to identify and describe traffic signs. The query transformer 606 includes an attention mechanism in which the queries are the image-based inputs (e.g., image embeddings output by the image transformer 614), the keys are the text-based inputs (e.g., the text embeddings output by the text transformer 616), and the values are a positive/negative rank of a pair of particular image embedding and particular text embedding. By combining the attention weights from the image transformer 614 and the text transformer 616, the query transformer 606 of the model 406 can learn the importance of different regions of an image frame 420 and the corresponding words in the annotation taxonomy data 608.

The image transformer 614 works on the perspective view features 604 extracted by the image encoder 602 and includes several self-attention layers to capture dependencies and relationships within the perspective view features 604. The image transformer 614 is trained to extract image embeddings 702 of different regions (e.g., patches) of an image frame 420. Each patch can be treated as a token and using positional encodings to maintain spatial information. For example, given an image tensor S with dimensions [H, W, C], patches can be extracted using a sliding window approach. The sliding window approach may be executed based on Equation 1 below in which P_{i,t} represent the t^{th} token in patch Pᵢ. Each patch Pᵢ can be converted into a token by flattening the pixel values of the patch Pᵢ and introducing positional encodings to retain spatial information. In an example, the image tensor S is passed through a convolutional layer with kernel size R, stride D and appropriate padding to generate the patches, which can be represented by Equation 2 below in which the variable Wis a weight, b is the bias, and K is the kernel value (R×R). The convolutional layer contains C filters to generate C feature maps. Each patch P_{i,t} is a flattened vector of size R*R*C. The patches are extracted by the image transformer 614 to determine image embeddings capturing visual information.

$${P}_{i} = \{ {P}_{i} , {P}_{i , 2} , … , {P}_{i , t} \} , where t = \frac{( H - R )}{D} \times \frac{W - R}{D} \qquad Equation 1$$

$${P}_{i , t} = {\sum }_{m = 0}^{R - 1} {\sum }_{n = 0}^{R - 1} {\sum }_{c = 0}^{C - 1} K ( m , n , c ) * W ( mS + m , nS + n , c ) + b ( c ) ] \qquad Equation 2$$

The text transformer 616 is trained to extract text embeddings 704 from the embedding vectors provided to the text transformer 616 based on an attention mechanism, such as a multi-head attention mechanism. The multi-head attention mechanism calculates the relevance of each token to every other token in the embedding vectors and allows the model 406 to learn the taxonomy of the annotation taxonomy data 608 in an end-to-end manner. In an example, the query (Qᵢ), key (Kᵢ), and value (Vᵢ) vectors are determined for each token based on Equation 3 below in which Qᵢ^{h}, Kᵢ^{h}, and Vᵢ^{h} are learnable weight matrices for query, key and value projections for each head h. Attention weights α_{i,j}^{h} can then be computed for each token head according to Equation 4 below in which dₖ is the dimension of key vectors. The output Oᵢ^{h} from each head is calculated as a weighted sum of values according to Equation 5 below. The outputs from all of the heads are then concatenated and passed through a final linear layer to get an overall attention output Fₜ, according to Equation 6, in which H represents the number of heads. The overall attention output Fₜ captures relationships between all tokens to represent the full taxonomy of the annotation taxonomy data 608.

$${Q}_{i}^{h} = {T}_{emb} \cdot {W}_{q}^{h} \vert {K}_{i}^{h} = {T}_{emb} \cdot {W}_{k}^{h} \vert {V}_{i}^{h} = {T}_{emb} \cdot {W}_{v}^{h} \qquad Equation 3$$

$${α}_{i , j}^{h} = Softmax ( \frac{{Q}_{i}^{h} \cdot {K}_{j}^{h}}{\sqrt{{d}_{k}}} \qquad Equation 4$$

$${O}_{i}^{h} = {\sum }_{j} {α}_{i , j}^{h} \cdot {V}_{j}^{h} \qquad Equation 5$$

$${F}_{c} = Concat ( {O}_{1}^{h} , {O}_{2}^{h} , … {O}_{H}^{h} ) \cdot {W}^{O} \qquad Equation 6$$

Training the query transformer 606 may involve various training schemes having different objectives, all of which enforce the queries of the attention mechanism to extract visual representations most relevant to the keys of textual information. At block 618, one objective includes performing fine-grained alignment between image and text embeddings based on an image-text matching technique that aims to capture detailed associations and relationships between the visual and textual modalities. A bi-directional self-attention mask can be used to allow all queries and texts to attend to each other, capturing multi-modal interactions. In an example, the image-text matching is achieved using a two-class linear classifier. Each query embedding Q is individually fed into a two-class linear classifier to predict the match/mismatch label. For instance, the prediction pred for each query embedding is calculated using a linear transformation function (Equation 7) and a softmax activation function (Equation 8). The predictions obtained from the two-class linear classifiers are averaged across all queries to obtain a final matching score according to Equation 9.

$$log {its}_{q} = {W}_{q} * Q + {b}_{q} \qquad Equation 7$$

$${pred}_{q} = softmax ( log {its}_{q} ) \qquad Equation 8$$

$$score = \frac{1}{{N}_{Q}} {\sum }_{q = 1}^{{N}_{Q}} {pred}_{q} \qquad Equation 9$$

In at least some embodiments, a hard negative mining strategy is used to create informative negative pairs. Hard negative mining creates informative negative pairs during the training phase to improve the ability of the query transformer 606 of the model 406 to distinguish between positive and negative image-text pairs. The query transformer 606 is trained to boost the score of the positive samples using Negative Log Likelihood (NLL) loss. The image-text matching technique helps the query transformer 606 learn to understand the importance of different regions of an image frame 420 and the corresponding words in the annotation taxonomy data 608, which helps the model 406 determine coherent and contextually relevant descriptors 430.

At block 620, another objective includes using contrastive learning to bring the image embeddings 702 (Fₜ) and text embeddings 704 (Fᵢ) closer in a shared space based on similarity scores. In general, contrastive learning involves pitting the image transformer 614 and the text transformer 616 against one another such that the image transformer 614 gets better by the text transformer 616 and the text transformer 616 gets better by the image transformer 614. For instance, training the text transformer 616 to produce more meaningful keys enables training the image transformer 614 to focus on more relevant image embeddings.

The contrastive learning is achieved through the use of a contrastive loss function that requires corresponding image embeddings 702 and text embeddings 704 to be closer to each other while being farther away from other unrelated embeddings. From the computed pairwise similarities, the highest similarity value is selected as the image-text similarity, indicating the alignment between the image embedding 702 and the text embedding 704. A cosine similarity S_{img-text} (i, j) may be calculated between each pair of image embeddings 702 and text embeddings 704 according to Equation 10. Positive pairs can then be created by matching each image embedding 702 with a text embedding 704 that corresponds to the image embedding 702. Negative pairs can also be created by matching each image embedding 702 with text embeddings 704 from other traffic sign categories. To effectuate the contrastive learning, a contrastive loss function can be defined that encourages positive pairs to be close and negative pairs to be distant in the shared space. For example, Equation 11 shows an example contrastive loss function L_{contrastive}(i, j) in which N is the total number of pairs and t is a temperature parameter that scales the similarity scores before applying the softmax function thereby controlling the smoothness of the probability distribution. The contrastive loss is used during training to guide the query transformer 606 towards learning the relationship between images and text. By minimizing the contrastive loss, the query transformer 606 learns to generate more accurate textual descriptions for the input images.

$${S}_{img - text} ( i , j ) = \frac{{F}_{i} ( i ) \cdot {F}_{t} ( j )}{‖ {F}_{i} ( i ) ‖ \cdot ‖ {F}_{t} ( j ) ‖} \qquad Equation 10$$

$${L}_{contrastive} ( i , j ) = - log \frac{exp ( \frac{{S}_{img - text} ( i , j )}{τ} )}{{\sum }_{k = 1}^{N} exp ( \frac{{S}_{img - text} ( i , j )}{τ} )} \qquad Equation 11$$

At block 622, another objective includes minimizing image-grounded text generation loss through the use of a cross-entropy loss function Lₜₑₓₜ (Equation 12) that measures the discrepancy between the predicted text y_{pred} and the true text yₜᵣᵤₑ. Since the architecture of the query transformer 606 restricts direct interactions between the image encoder 602 and the text tokens, the query transformer 606 extracts necessary information from the patches during training through queries and then communicates this information to the text tokens using self-attention layers. This approach compels the queries to capture visual features that encompass all the required information for text generation. The queries interact with the visual features and capture the information needed for generating text. In at least some embodiments, to control the interaction between queries and text tokens, a multi-modal causal self-attention mask is employed, which allows queries to attend to each other while restricting the attention of the queries to text tokens. Each text token, on the other hand, can attend to both queries and previous text tokens.

$${L}_{text} = - \sum ( {y}_{true} \cdot log ( {y}_{pred} ) ) \qquad Equation 12$$

The decoding process involves generating text tokens based on the extracted visual features from the queries. In at least some embodiments, a [DEC] token is added to the features. The [DEC] token signifies the beginning of the decoding task and signals the query transformer 606 to start generating text. The multi-modal causal self-attention mask maintains controlled interactions between queries and text tokens, allowing for effective transfer of information from the visual to the textual modality. The cross-entropy function used during training of the model 406 is used to guide the query transformer 606 of the model 406 towards generating more accurate textual description for input images. By minimizing the cross-entropy loss, the model 406 learns to generate more coherent and contextually relevant text.

The text-grounded image embeddings 624 output by the query transformer 606 are projected into the same dimension as the large language model decoder 628. For example, the text-grounded image embeddings 624 are provided to the adaptation ML model 626 (e.g., a fully connected linear projection layer of the model 406), which is trained to project the text-grounded image embeddings 624 into the same dimension as the large language model decoder 628, allowing for meaningful interactions between the text-grounded image embeddings 624 and the large language model decoder 628. The projected embeddings output from the adaptation ML model 626 act as a soft visual prompt for the vision to language training. Additionally, the projected embeddings effectively function as an information bottleneck that feeds the most useful information to the large language model decoder 628 while removing irrelevant visual information. In this way, the projected embeddings reduce the burden on the large language model decoder 628 to learn vision-language alignment and mitigate the catastrophic forgetting problem.

The large language model decoder 628 is pre-trained to output natural language text based on input text-grounded image embeddings 624. For instance, the large language model encoder 612 is trained with the annotation taxonomy data 608 to output traffic sign descriptors. In at least some embodiments, the large language model decoder 628 is retrained with the projected text-grounded image embeddings 624 to incorporate visual cues/features to output natural language descriptors 430 of the image frames 420 (e.g., of the traffic sign(s) in the image frames 420) and values associated with the natural language descriptors 430. For example, the natural language descriptors 430 can include any one or more of the descriptors: “Circle” associated with a label value “Shape” and indicating that the traffic sign is a circle, “Red” associated with a label value “Color” and indicating that the traffic sign is red, “Merging” associated with a label value “Relevancy” and indicating that the traffic sign is relevant for vehicles in lanes that are merging, “30 m” associated with a label value “Text” and indicating that the traffic sign displays text that says 30 m, and “Warning” associated with a label value “Type” and indicating that the traffic sign is a warning rather than informational.

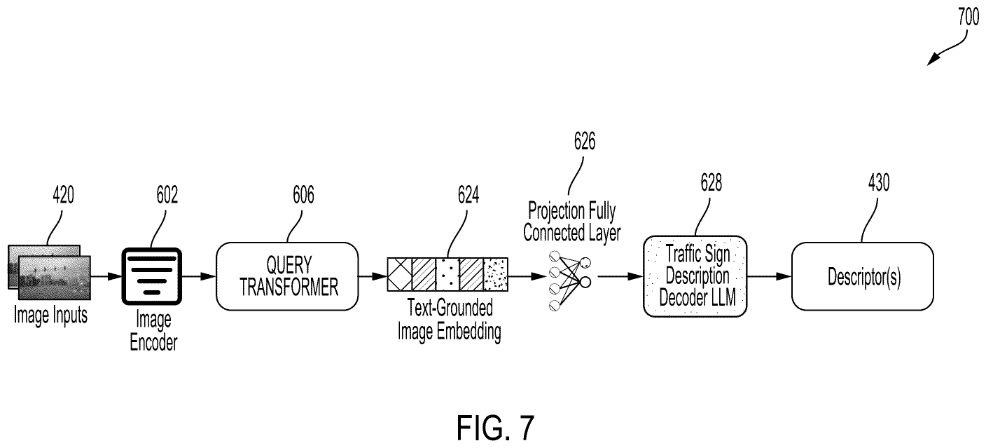

With the model 406 trained, FIG. 7 is a flow diagram of an example pipeline 700 implemented by the trained model 406 for determining the at least one descriptor 430 at the inference stage. Pipeline 700 includes at least one image frame 420 being provided to the image encoder 602. The image encoder 602 outputs the perspective view features 604, which are provided to the query transformer 606. There are not any annotations to help at the inference stage, but rather only the perspective view features 604 representative of a scene around a vehicle (e.g., vehicle 100) is input to the query transformer 606. During inference, the image transformer 614 is able to extract features from the perspective view features 604 that are not based just on the perspective view features 604, but rather also on text reasoning-based inputs. The training with the text transformer 616 influences the image transformer 614 during inference to be more inclusive of the contextual features so that the image transformer 614 extracts more meaningful features. The query transformer 606 thereby determines one or more text-grounded image embeddings 624.

The one or more text-grounded image embeddings 624 are provided to the adaptation ML model 626, which outputs projected embeddings that are input to the large language model decoder 628. The large language model decoder 628 outputs one or more natural language descriptors 430 corresponding to a traffic sign represented in the at least one image frame 420. In this way, the model 406 has the capacity to output natural language descriptors 430 of virtually any traffic sign, without having to train different ML models for different types of signs, as long as features of the traffic sign can be extracted from the at least one image frame 420 and the embeddings determined from those features can be projected into a dimension capable of being input into the large language model decoder 628.

The one or more descriptors 430 can be used to control one or more functions of a vehicle (e.g., vehicle 100). The improved traffic sign recognition represented by the one or more descriptors 430 enables vehicle control systems to more accurately understand and interpret the road environment so that the vehicle control systems can navigate the vehicle 100 in a way that complies with traffic regulations and reduces a risk of harm with respect to passengers, pedestrians, and other road users. Additionally, or alternatively, the natural language, human-readable text of the one or more descriptors 430 can be analyzed to understand the reasoning process of the model 406 with respect to traffic sign recognition.

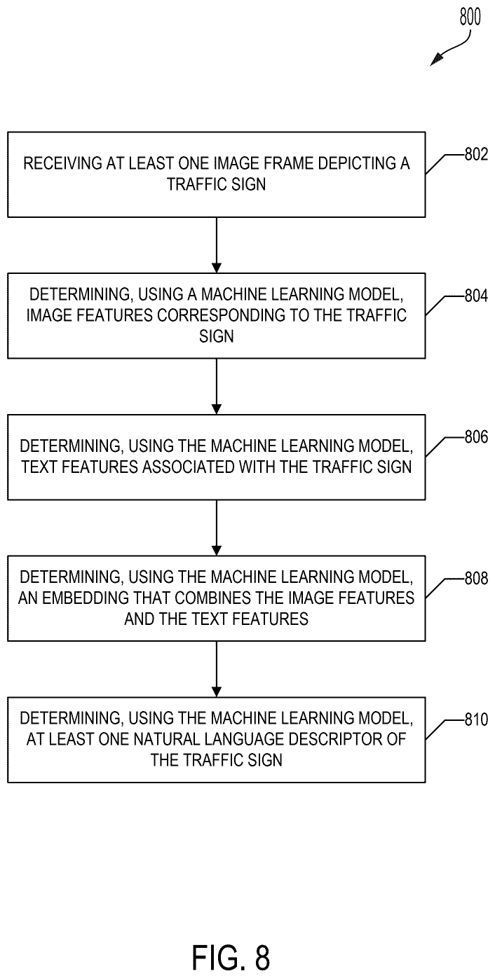

One method of performing image processing according to embodiments described above is shown in FIG. 8. FIG. 8 is a flow chart illustrating an example method 800 for determining at least one natural language descriptor of a traffic object. Method 800 includes, at block 802, receiving at least one image frame (e.g., image frame 420) depicting a traffic object (e.g., a traffic sign). In at least some embodiments, the at least one image frame 420 is received from at least one camera (e.g., cameras 203, 205) disposed on a vehicle (e.g., vehicle 100).

At block 804, image features (e.g., image embeddings 702) corresponding to the traffic sign are determined using a machine learning model (e.g., model 406) based on the at least one image frame 420. In various embodiments, the image embeddings 702 are determined based on first image features (e.g., features 604) extracted from the at least one image frame 420. In various embodiments, the image embeddings 702 are determined based on extracting patches corresponding to the traffic sign from the first image features 604.

At block 806, text features (e.g., text embeddings 704) associated with the traffic sign are determined using the machine learning model 406 based on the at least one image frame 420. In various embodiments, the text embeddings 704 are determined based on the first image features 604 extracted from the at least one image frame 420.

At block 808, an embedding (e.g., text-grounded image embedding 624) that combines the image embeddings 702 and the text embeddings 704 is determined using the machine learning model 406. In various embodiments, determining the embedding 624 is based on a contrastive loss function.

At block 810, at least one natural language descriptor (e.g., descriptor 430) of the traffic sign is determined using the machine learning model 406 based on the embedding 624. In various embodiments, the at least one natural language descriptor 430 is determined using a large language machine learning model (e.g., model 628) of the machine learning model 406. In various embodiments, the at least one natural language descriptor 430 includes at least one characteristic of the traffic sign in the group consisting of: a shape, a color, a type, text displayed, and an intended recipient. For example, an intended recipient may be all vehicles driving past the traffic sign, or only vehicles that are making a right turn at an intersection.

In some aspects, the method 800 may further include controlling a function of the vehicle 100 based on the descriptor 430. For example, the descriptor 430 may be input to a driving assistance system that processes the descriptor 430 to control functions of the vehicle 100.

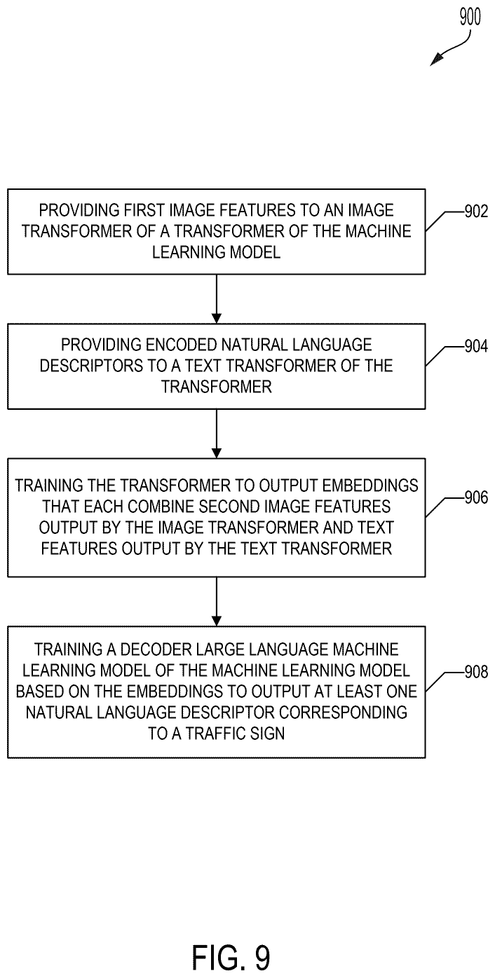

One method of training a machine learning model to perform image processing according to embodiments described above is shown in FIG. 9. FIG. 9 is a flow chart illustrating an example method 900 for training a machine learning model (e.g., model 406) to receive at least one image frame (e.g., image frame 420) depicting a traffic sign as input and output at least one natural language descriptor (e.g., descriptor 430) of the traffic sign. Method 900 includes, at block 902, providing first image features (e.g., image features 604) to an image transformer (e.g., image transformer 614) of a transformer (e.g., transformer 606) of the machine learning model 406. The first image embeddings 702 correspond to a plurality of image frames (e.g., image frames 420) depicting a plurality of traffic signs.

At block 904, natural language descriptors (e.g., annotations 608) are encoded and provided to a text transformer (e.g., text transformer 616) of the transformer 606. The natural language descriptors 430 correspond to the plurality of traffic signs. In various embodiments, an encoder large language machine learning model (e.g., model 612) is pre-trained based on natural language annotations 608 of the plurality of traffic signs to output the encoded natural language descriptors 608 that are provided to the text transformer 616.

At block 906, the transformer 606 is trained to output embeddings (e.g., text-grounded image embeddings 624) that each combine second image features (e.g., image embeddings 702) output by the image transformer 614 and text features (e.g., text embeddings 704) output by the text transformer 616. The second image embeddings 702 correspond to a traffic sign of the plurality of traffic signs and the text embeddings 704 correspond to the traffic sign. In various embodiments, training the transformer 606 is based on contrastive learning between the image transformer 614 and the text transformer 616. In various embodiments, in an attention-based mechanism of the transformer 606, a query is a patch including a portion of the second image embeddings 702, a key is a portion of the text embeddings 704, and a value indicates whether a pair including the patch and the portion of the text embeddings 704 is a positive pair or a negative pair.

At block 908, the method 900 includes training a decoder large language machine learning model (e.g., model 628) of the machine learning model 406 based on the embeddings 624 to output at least one natural language descriptor (e.g., descriptor 430) corresponding to the traffic sign. In various embodiments, the at least one natural language descriptor 430 includes at least one characteristic of the traffic sign in the group consisting of: a shape, a color, a type, text displayed, and an intended recipient. For example, an intended recipient may be all vehicles driving past the traffic sign, or only vehicles that are making a right turn at an intersection.

FIG. 10 is a flow diagram of an example pipeline 1000 for determining the intersection state 432 at the inference stage. Pipeline 1000 may be implemented by model 408. At blocks 710-714 of pipeline 1000, the at least one image frame 420 is input into each of the perception modules including a traffic light state detection module, a vehicle detection module, and a lane detection module. The traffic light state detection module may output data indicative of a state (e.g., color, shape, etc.) of one or more traffic lights. The lane detection module may output data indicative of detected traffic lanes. The vehicle detection module may output data indicative of a detected vehicle and provide that output to the vehicle tracking module. At block 718, a GPS/INS module may output position information 422 that is also provided to the vehicle tracking module. At block 716, the vehicle tracking module may output data indicative of a trajectory of a detected vehicle. Each of the outputs from the perception modules and the GPS/INS module is provided to a traffic light relevancy extractor at block 720.

At block 722, a scene graph is constructed based on each of the outputs from the perception modules and the GPS/INS module. A scene graph is a graph-based data structure used to organize and represent objects within a scene around vehicle 100. At block 724, the scene graph is passed through a graph attention encoder layer that outputs embeddings encoding relationships between vehicles, lanes, and traffic lights. At block 726, the embeddings are provided to a first graph decoder that outputs TL-lane features indicative of associations between traffic lights (TL) of an intersection and traffic lanes. The TL-lane features may be in the form of a bipartite graph at block 728. As an example, consider a scenario in which there are two traffic lanes (L1 and L2) that cross over another two traffic lanes (L3 and L4) at an intersection that includes four traffic lights (TL1, TL2, TL3, and TL4) for which the correct association between the traffic lanes and the traffic lights is not known. Traffic light TL4 is associated with lanes L3 or L4 and can be disregarded. At a first time instance, vehicle 100 is driving behind a first vehicle (V1) in lane L1 and next to a second vehicle (V2) that is driving in lane L2, and each of the vehicles is far away from the intersection. As such, at this first time instance, all combinations of lanes L1, L2 and traffic lights TL1, TL2, and TL3 are possible.

At a second time instance subsequent to the first time instance, vehicle V1 in lane L1 is close to the intersection and slows down due to a change in the state of traffic light TL1. It can thereby be determined that lane L1 is associated with traffic light TL1. All combinations of lane L2 and traffic lights TL1, TL2, and TL3 remain possible. At a third time instance subsequent to the second time instance, vehicle V1 in lane L1 and vehicle V2 in lane L2 are both close to the intersection. Vehicle V2 speeds up due to a change in the state of traffic light TL2. It can thereby be determined that lane L2 is associated with traffic light TL2. A traffic light relevant to the vehicle 100 can be determined based on which lane L1 or L2 the vehicle 100 is driving in.

At block 730, the embeddings are provided to a second graph decoder that outputs TL-vehicle features indicative of associations between traffic lights (TL) of an intersection and vehicles. The output features may be in the form of a bipartite graph at block 732. Determining the features indicative of associations between traffic lights and vehicles may be based on obstacle tracklets such that the determination is independent of how a state of any of the traffic lights is extracted. Generating separate bipartite graphs to represent traffic light-lane and traffic light-vehicle relationships enables capturing both static (e.g., stationary traffic lanes) and dynamic (e.g., moving vehicles) relevancy of traffic lights. As another example with the same scenario described above, the future path of the vehicles V1 and V2 is not known to vehicle 100 nor is the relevancy of the traffic lights for each vehicle V1 and V2. At a first time instance, vehicle 100 is driving behind vehicle V1 in lane L1 and next to a vehicle V2 that is driving in lane L2, and each of the vehicles is far away from the intersection. As such, at this first time instance, all combinations of vehicles 100, V1, and V2 and traffic lights TL1, TL2, and TL3 are possible.

At a second time instance subsequent to the first time instance, vehicle 100 is trying to take a right turn from lane L2 to lane L3, and vehicle V1 in lane L1 drives straight through the intersection despite a change in the state of traffic light TL3. It can thereby be determined that vehicle V1 is associated with traffic lights TL1 or TL2, but not with traffic light TL3. Since vehicle 100 is trying to make a right turn, the trajectory of vehicle 100 can be used in determining that vehicle 100 is associated with traffic light TL2 or TL3, but not with traffic light TL1. Additionally, the position information 422 from the GPS/INS module may indicate that traffic lights TL2 and TL3 are positioned near lane L2, from which vehicle 100 is trying to turn, whereas traffic light TL1 is positioned near lane L1, making TL2 and TL3 more relevant to vehicle 100 than TL1. All combinations of vehicle V2 and traffic lights TL1, TL2, and TL3 remain possible.

At a third time instance subsequent to the second time instance, vehicle V2 is closer to the intersection than vehicle 100 and drives straight through the intersection while vehicle 100 slows down to make the right turn. Since vehicles V1 and V2 both drive straight through the intersection despite the change in traffic light TL3, it can be determined that vehicles V1 and V2 are both not associated with traffic light TL3. It can also be determined that, because vehicle 100 slows down in contrast to vehicles V1 and V2, vehicle V1 is associated with traffic light TL3. It will be appreciated that, in some intersections, more than one traffic light may be relevant to a vehicle. For instance, a large intersection may include two traffic lights that have states that are in sync with one another (e.g., green at the same time, yellow at the same time, and red at the same time).

At block 734, the TL-lane features and the TL-vehicle features are merged to determine the intersection state 432. The intersection state 432 includes all of the known information regarding traffic light-traffic lane associations and traffic light-vehicle associations. In some embodiments, at block 736, the intersection state 432 may be provided to a path planning module, along with the outputs of the lane detection module, the vehicle tracking module, and the GPS/INS module, to determine a planned path for vehicle 100. For example, the planned path may be determined based on which traffic light is relevant to vehicle 100 and a state of that relevant traffic light. The planned path may be provided to a decision-making module that evaluates the planned path to ascertain appropriate actions for controlling vehicle 100.

Each of the traffic light state detection, lane detection, vehicle detection, vehicle tracking, GPS/INS, path planning, and decision-making modules may be implemented as a respective machine learning model. Model 408 includes each of the respective machine learning models. In some embodiments, each of the traffic light state detection, lane detection, vehicle detection, vehicle tracking, GPS/INS, path planning, and decision-making modules may be implemented as a part of single model that can be trained in an end-to-end fashion.

It is noted that one or more blocks (or operations) described with reference to FIGS. 6-10 may be combined with one or more blocks (or operations) described with reference to another of the figures. For example, one or more blocks (or operations) of FIGS. 6-10 may be combined with one or more blocks (or operations) of FIG. 1-3. As another example, one or more blocks associated with FIGS. 6-10 may be combined with one or more blocks associated with FIG. 4. As another example, one or more blocks of FIG. 8 may be combined with one or more blocks associated with FIG. 7. As another example, one or more blocks of FIG. 9 may be combined with one or more blocks associated with FIG. 6.

In one or more aspects, techniques for supporting vehicular operations may include additional aspects, such as any single aspect or any combination of aspects described below or in connection with one or more other processes or devices described elsewhere herein. In a first aspect, an apparatus is configured to receive a plurality of image frames. A traffic sign is depicted in the plurality of image frames. The apparatus is further configured to extract image features corresponding to the traffic sign based on the at least one image frame; determine, using at least one machine learning model, an embedding based on the image features and text included on the traffic sign; and determine, using the at least one machine learning model, at least one natural language descriptor of the traffic sign based on the embedding. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the at least one natural language descriptor is determined using a large language machine learning model of the machine learning model.

In a third aspect, in combination with the second aspect, the at least one natural language descriptor includes at least one characteristic of the traffic sign in the group consisting of: a shape, a color, a type, text displayed, and an intended recipient.

In a fourth aspect, in combination with one or more of the first aspect through the third aspect, the plurality of image frames also depict a plurality of traffic lights, and the apparatus is further configured to determine a relevant traffic light of the plurality of traffic lights based on a state of at least one of the plurality of traffic lights, at least one detected traffic lane, and a trajectory of at least one detected vehicle.

In a fifth aspect, in combination with the fourth aspect, determining the relevant traffic light includes determining a graph-based data structure representative of an intersection, the at least one detected traffic lane, and the at least one detected vehicle. The intersection includes the plurality of traffic lights.

In a sixth aspect, in combination with the fourth aspect, determining the relevant traffic light includes: determining at least one association between the plurality of traffic lights and the at least one detected traffic lane; and determining at least one association between the plurality of traffic lights and the at least one detected vehicle.

In a seventh aspect, in combination with one or more of the first aspect through the sixth aspect, the at least one image frame is received from at least one camera disposed on a vehicle.

In an eighth aspect, in combination with one or more of the first aspect through the seventh aspect, the apparatus is further configured to control a function of a vehicle based on the at least one natural language descriptor.

In an ninth aspect, in combination with one or more of the second aspect through the seventh aspect, a method includes receiving a plurality of image frames. A traffic sign is depicted in the plurality of image frames. The method further includes extracting image features corresponding to the traffic sign based on the at least one image frame; determining, using at least one machine learning model, an embedding based on the image features and text included on the traffic sign; and determining, using the at least one machine learning model, at least one natural language descriptor of the traffic sign based on the embedding.

In a tenth aspect, a method of training a machine learning model includes providing first image features to an image transformer of a transformer of the machine learning model. The first image features correspond to a plurality of image frames depicting a plurality of traffic signs. The method further includes providing encoded natural language descriptors to a text transformer of the transformer. The natural language descriptors correspond to the plurality of traffic signs. The transformer is trained to output embeddings that each combine second image features output by the image transformer and text features output by the text transformer. The second image features correspond to a traffic sign of the plurality of traffic signs and the text features correspond to the traffic sign. The method also includes training a decoder large language machine learning model of the machine learning model based on the embeddings to output at least one natural language descriptor corresponding to the traffic sign.

In an eleventh aspect, in combination with the tenth aspect, an encoder large language machine learning model is pre-trained based on natural language annotations of the plurality of traffic signs to output the encoded natural language descriptors provided to the text transformer.

In a twelfth aspect, in combination with the tenth aspect or the eleventh aspect, training the transformer is based on contrastive learning between the image transformer and the text transformer.

In a thirteenth aspect, in combination with the twelfth aspect, in an attention-based mechanism of the transformer, a query is a patch including a portion of the second image features, a key is a portion of the text features, and a value indicates whether a pair including the patch and the portion of the text features is a positive pair or a negative pair.

In a fourteenth aspect, in combination with one or more of the first aspect through the thirteenth aspect, the at least one natural language descriptor includes at least one characteristic of the traffic sign in the group consisting of: a shape, a color, a type, text displayed, and an intended recipient.

Components, the functional blocks, and the modules described herein with respect to FIGS. 1-7 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for image processing, comprising:
receiving a plurality of image frames, wherein a traffic sign is depicted in the plurality of image frames;
extracting image features corresponding to the traffic sign based on the at least one image frame;
determining, using at least one machine learning model, an embedding based on the image features and text included on the traffic sign; and
determining, using the at least one machine learning model, at least one natural language descriptor of the traffic sign based on the embedding.

2. The method of claim 1, wherein the at least one natural language descriptor is determined using a large language machine learning model of the at least one machine learning model.

3. The method of claim 1, wherein the at least one natural language descriptor includes at least one characteristic of the traffic sign in the group consisting of: a shape, a color, a type, text displayed, and an intended recipient.

4. The method of claim 1, wherein the plurality of image frames also depict a plurality of traffic lights, the method further comprising determining a relevant traffic light of the plurality of traffic lights based on a state of at least one of the plurality of traffic lights, at least one detected traffic lane, and a trajectory of at least one detected vehicle.

5. The method of claim 4, wherein determining the relevant traffic light includes determining a graph-based data structure representative of an intersection, the at least one detected traffic lane, and the at least one detected vehicle, wherein the intersection includes the plurality of traffic lights.

6. The method of claim 4, wherein determining the relevant traffic light includes:
determining at least one association between the plurality of traffic lights and the at least one detected traffic lane; and
determining at least one association between the plurality of traffic lights and the at least one detected vehicle.

7. The method of claim 1, wherein the plurality of image frames are received from at least one camera disposed on a vehicle.

8. The method of claim 1, further comprising controlling a function of a vehicle based on the at least one natural language descriptor.

9. An apparatus, comprising:
a memory storing processor-readable code; and
at least one processor coupled to the memory, the at least one processor configured to execute the processor-readable code to cause the at least one processor to perform operations including:
receiving a plurality of image frames, wherein a traffic sign is depicted in the plurality of image frames;
determining, using at least one machine learning model, image features corresponding to the traffic sign based on the plurality of image frames;
determining, using the at least one machine learning model, text features associated with the traffic sign based on the plurality of image frames;
determining, using the at least one machine learning model, an embedding that combines the image features and the text features; and
determining, using the at least one machine learning model, at least one natural language descriptor of the traffic sign based on the embedding.

10. The apparatus of claim 9, wherein the at least one natural language descriptor is determined using a large language machine learning model of the at least one machine learning model.

11. The apparatus of claim 9, wherein the at least one natural language descriptor includes at least one characteristic of the traffic sign in the group consisting of: a shape, a color, a type, text displayed, and an intended recipient.

12. The apparatus of claim 9, wherein the plurality of image frames also depict a plurality of traffic lights, the operations further including determining a relevant traffic light of the plurality of traffic lights based on a state of at least one of the plurality of traffic lights, at least one detected traffic lane, and a trajectory of at least one detected vehicle.

13. The apparatus of claim 12, wherein determining the relevant traffic light includes determining a graph-based data structure representative of an intersection, the at least one detected traffic lane, and the at least one detected vehicle, wherein the intersection includes the plurality of traffic lights.

14. The apparatus of claim 12, wherein determining the relevant traffic light includes:
determining at least one association between the plurality of traffic lights and the at least one detected traffic lane; and
determining at least one association between the plurality of traffic lights and the at least one detected vehicle.

15. The apparatus of claim 9, wherein the plurality of image frames are received from at least one camera disposed on a vehicle.

16. The apparatus of claim 9, wherein the operations further include controlling a function of a vehicle based on the at least one natural language descriptor.

17. A method of training at least one machine learning model, comprising:
providing first image features to an image transformer of a transformer of the at least one machine learning model, the first image features corresponding to a plurality of image frames depicting a plurality of traffic signs;
providing encoded natural language descriptors to a text transformer of the transformer, the encoded natural language descriptors corresponding to the plurality of traffic signs;
training the transformer to output embeddings that each combine second image features output by the image transformer and text features output by the text transformer, wherein the second image features correspond to a traffic sign of the plurality of traffic signs and the text features correspond to the traffic sign; and
training a decoder large language machine learning model of the at least one machine learning model based on the embeddings to output at least one natural language descriptor corresponding to the traffic sign.

18. The method of claim 17, wherein an encoder large language machine learning model of the at least one machine learning model is pre-trained based on natural language annotations of the plurality of traffic signs to output the encoded natural language descriptors provided to the text transformer.

19. The method of claim 17, wherein training the transformer is based on contrastive learning between the image transformer and the text transformer.

20. The method of claim 17, wherein the at least one natural language descriptor includes at least one characteristic of the traffic sign in the group consisting of: a shape, a color, a type, text displayed, and an intended recipient.
